(19) United States
(12) Patent Application Publication
(10) Pub. No.: US 2005/0179840 A1
(43) Pub. Date: Aug. 18, 2005

(54) Color filter panel, display apparatus having the same, and method of manufacturing the same

(75) Inventors: Won-Sang Park, Gyeonggi-do (KR); Sang-Woo Kim, Gyeonggi-do (KR); Jae-Young Lee, Seoul (KR); Sung-Eun Cha, Gyeongsangnam-do (KR); Jae-Ik Lim, Gangwon-do (KR); Jae-Hyun Kim, Gyeonggi-do (KR); Do-Hyung Kim, Gyeonggi-do (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 11/031,938

(22) Filed: Jan. 6, 2005

(30) Foreign Application Priority Data
Jan. 6, 2004 (KR) 2004-00515
Feb. 13, 2004 (KR) 2004-09559
Jun. 1, 2004 (KR) 2004-39552

(51) Int. Cl. G02F 1/1335

(52) U.S. Cl. 349/114; 349/106

(57) ABSTRACT

A color filer panel includes a first substrate, a light reflecting member, a color filter, and a light polarizing layer. The light reflecting member is formed on the first substrate. The light reflecting member reflects at least a portion of an external light. The color filter is formed on the light reflecting member. The light polarizing layer is formed over the color filter. Advantageously the time for manufacturing the color filter panel is reduced. Furthermore, a misalignment between the first substrate and the light reflecting member or between the first substrate and the light polarizing layer, which occurs when the light reflecting member or the light polarizing layer is formed in a plate type, is reduced to enhance productivity. Additionally, the light before and after being reflected by the light reflecting member has substantially the same color to enhance display quality.

### CROSS-REFERENCE TO RELATED APPLICATIONS

This application relies for priority upon Korean Patent Application No. 2004-00515 filed on Jan. 6, 2004, Korean Patent Application No.2004-09559 filed on Feb. 13, 2004, and Korean Patent Application No.2004-39552 filed on Jun. 1, 2004, the contents of which are herein incorporated by reference in their entireties.

### BACKGROUND

1. Field of the Invention

The present invention relates to a color filter panel, a display apparatus having the color filter panel, and a method of manufacturing the color filter panel.

2. Description of the Related Art

Generally, a transflective type display apparatus or a semi-reflective type display apparatus includes a display panel for displaying an image and a light generating part for providing the display panel with a light.

The display panel includes a switch panel, a color filter panel, and a liquid crystal layer. The switch panel is adjacent to the light generating part. The color filter panel faces the switch panel. The liquid crystal layer is interposed between the color filter panel and the switch panel. Upper and lower polarizing plates are disposed on the color filter panel and the switch panel, respectively.

The color filter panel includes a substrate, a color filter layer and a common electrode having a material that is optically transparent. The color filter layer has red, green, and blue color filters.

The switch panel of the transflective display apparatus includes a thin film transistor and a pixel electrode that is electrically connected to the thin film transistor. The pixel electrode includes a transparent electrode and a reflective electrode. The transparent electrode transmits an external light. The reflective electrode reflects an external light. Lower and upper quarter wave plates are disposed on the lower and upper surfaces of the liquid crystal display panel, respectively. The lower and upper quarter wave plates convert a linearly polarized light into a circularly polarized light, or vice versa. Additionally, lower and upper polarizing plates are disposed on lower and upper quarter wave plates, respectively.

A switch panel of the semi-reflective display apparatus includes a thin film transistor and a pixel electrode that is electrically connected to the thin film transistor. The switch panel of the semi-reflective display apparatus further includes a semi-reflective film disposed under the switch panel. The semi-reflective film transmits a major portion of a first light having a specific polarization axis, and reflects a minor portion of the first light. The semi-reflective film reflects a second light having a second polarization axis that is not parallel with the first polarization axis.

Generally, the first polarization axis is parallel with a polarization axis of the lower polarizing plate, and the semi-reflective film transmits the first light by about 90% and reflects the first light by about 10%.

The transflective display apparatus includes not only lower and upper polarizing plates but also lower and upper quarter wave plates. Therefore, the cost of manufacturing the transflective type apparatus is higher than that of the semi-reflective display apparatus. Furthermore, in a transmission mode, the transflective type display apparatus has a lower transmissivity and contrast ratio than that of a transmissive type display apparatus. Therefore, a display quality of the transflective type display apparatus is lower than a display quality of the transmissive type display apparatus.

Additionally, phase difference And of the liquid crystal layer of the transflective type display apparatus is lower than that of the transmissive type display apparatus. In detail, a gap ‘d’ of the liquid crystal layer and an anisotropy of refractivity ‘Δn’ of the transflective type display apparatus are lower than that of the transmissive type display apparatus. Therefore, adjusting cell gap ‘d’ of the transflective type display is much harder than that of the transmissive type display apparatus. Furthermore, the switch panel and the color filter panel of the transflective type display apparatus may be electrically shorted due to the small cell gap. Therefore, productivity is reduced.

In case of the semi-reflective type display apparatus, the semi-reflective film may move slightly. Therefore, a misalignment between the semi-reflective film and the display panel may happen to reduce a productivity of the semi-reflective type display apparatus.

### SUMMARY

The present invention provides a color filter panel capable of enhancing a display quality and productivity.

The present invention also provides a display panel having the color filter panel.

The present invention also provides a display apparatus having the color filter panel.

The present invention also provides a method of manufacturing the color filter panel.

According to an embodiment of the present invention, a color filter panel includes a first substrate, a light reflecting member, a color filter, and a light polarizing layer. The light reflecting member is formed on the first substrate. The light reflecting member reflects at least a portion of an external light. The color filter is formed on the light reflecting member. The light polarizing layer is formed on the color filter.

According to another embodiment of the present invention, a display panel includes a color filter panel, a switch panel, and a liquid crystal layer. The color filter panel includes a first substrate, a light reflecting member, a color filter, and a light polarizing layer. The light reflecting member is formed on the first substrate. The light reflecting member reflects at least a portion of an external light. The color filter is formed on the light reflecting member. The light polarizing layer is formed on the color filter. The switch panel combines with the color filter panel such that the switch panel faces the color filer panel. The switch panel includes a second substrate, a black matrix formed on a portion of the second substrate, a thin film transistor formed on the black matrix, and a pixel electrode that is electrically connected to the thin film transistor. The liquid crystal layer is interposed between the color filter panel and the switch panel.

According to another embodiment of the present invention, a display apparatus includes a light generating part, a color filter panel, a switch panel, and a liquid crystal layer. The light generating part generates a light. The color filter panel includes a first substrate, a light reflecting member, a color filter and a light polarizing layer. The light reflecting member is formed on the first substrate. The light reflecting member reflects at least a portion of an external light. The color filter is formed on the light reflecting member. The light polarizing layer is formed on the color filter. The switch panel combines with the color filter panel such that the switch panel faces the color filer panel. The switch panel includes a second substrate, a black matrix formed on a portion of the second substrate, a thin film transistor formed on the black matrix, and a pixel electrode that is electrically connected to the thin film transistor. The liquid crystal layer is interposed between the color filter panel and the switch panel.

According to a method of manufacturing a color filter panel, a light reflecting member that reflects at least a portion of an external light is formed on the first substrate. A color filter layer is formed on the light reflecting member. A light polarizing layer is formed on the color filter.

Advantageously, a time for manufacturing the display panel is reduced. Furthermore, a misalignment between the first substrate and the light reflecting member or between the first substrate and the light polarizing layer, both of which can occur when the light reflecting member or the light polarizing layer is formed in a plate type, is reduced to enhance productivity.

Additionally, the color filter layer is formed on the reflecting member. Therefore, the second lights before and after being reflected by the light reflecting member have the same color. That is, the second light maintains color even when the second light is reflected by the light reflecting member. Therefore, display quality is enhanced.

### BRIEF DESCRIPTION OF THE DRAWINGS

The above and other features and advantages of the present invention will become more apparent by describing in detailed embodiments thereof with reference to the accompanying drawings, in which:

FIG. 1 is a cross-sectional view illustrating a color filter panel according to a first embodiment of the present invention;

FIG. 2 is a cross-sectional view illustrating a color filter panel according to a second embodiment of the present invention;

FIGS. 3A to 3F are cross-sectional views illustrating a method of manufacturing the color filter panel in FIG. 1;

FIG. 4 is a cross-sectional view illustrating a display apparatus having the color filter panel in FIG. 1 in accordance with an embodiment of the present invention;

FIG. 5 is a cross-sectional view illustrating a switch panel in FIG. 4;

FIG. 6 is a schematic perspective view illustrating a relationship between transmission axes of a light polarizing layer and an upper light polarizing plate in FIG. 4;

FIGS. 7A to 7E are cross-sectional views illustrating a method of manufacturing the switch panel in FIG. 5;

FIG. 8 is a cross-sectional view illustrating a display panel having the color filter panel in FIG. 2 in accordance with another embodiment of the present invention;

FIG. 9 is a plan view illustrating a reflecting member formed on a first substrate of a color filter panel in FIG. 8;

FIGS. 10A and 10B are cross-sectional views illustrating a switch panel in FIG. 8;

FIG. 11 is a schematic perspective view illustrating a relationship between transmission axes of a light polarizing layer and a lower light polarizing plate in FIG. 8;

FIG. 12 is a schematic perspective view illustrating a relationship between transmission axes of a light polarizing layer and an upper light polarizing plate in FIG. 8;

FIG. 13 is a cross-sectional view illustrating a display apparatus according to another embodiment of the present invention;

FIG. 14 is a schematic view illustrating a polarizing state, when a display panel according to the present invention displays an image by using a second light that corresponds to an external light; and

FIG. 15 is a schematic view illustrating a light polarizing state, when a display panel according to the present invention displays an image by using a first light that corresponds to an internal light.

### DETAILED DESCRIPTION

Hereinafter the embodiments of the present invention will be described in detail with reference to the accompanying drawings.

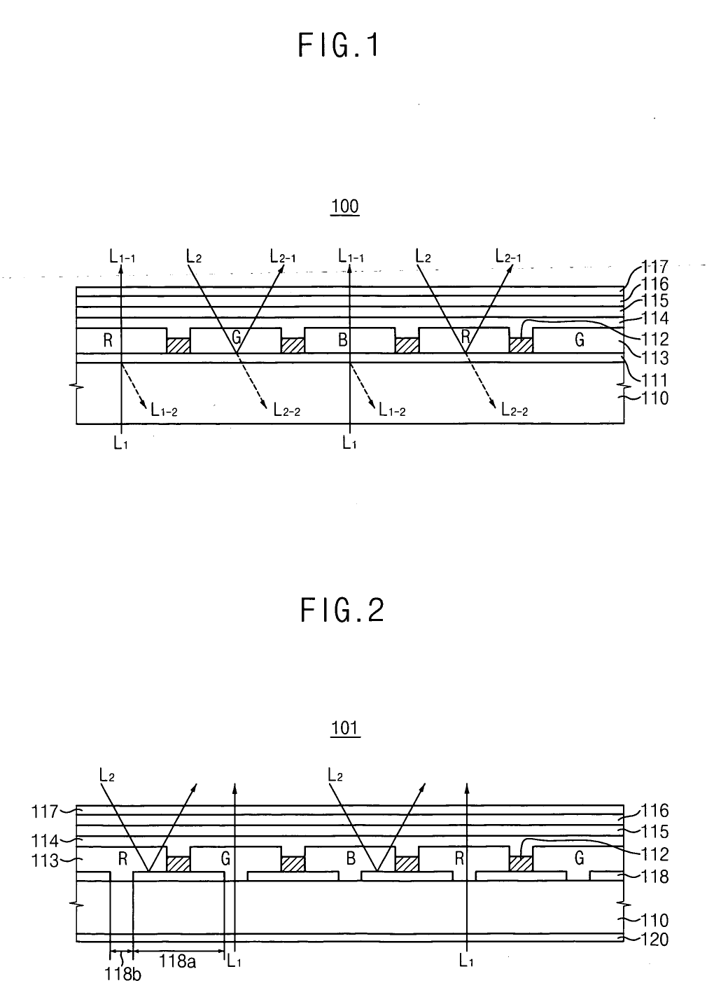

FIG. 1 is a cross sectional view illustrating a color filter panel according to a first embodiment of the present invention. Referring to FIG. 1, a color filter panel 100 is combined with a switch panel (not shown) to form a display panel (not shown). The color filter panel 100 is adjacent to an internal light generating part (not shown) that generates a first light L1 advancing toward a first substrate 110 of the color filter panel 100. Alternatively, a lower polarizing plate (not shown) may be disposed on a lower surface of the first substrate 110.

The color filter panel 100 includes the first substrate 110, a light reflecting member 111 disposed on the first substrate 110, and a light polarizing layer 115 disposed over the light reflecting member 111. A first light blocking layer 112 and a color filter layer 113 are interposed between the light reflecting member 111 and the light polarizing layer 115. A first leveling layer 114 may be formed on the color filter layer 113 and the first light blocking layer 112. A first protection layer 116 is formed on the light polarizing layer 115, and a common electrode 117 is formed on the first protection layer 116.

The light reflecting member 111 transmits a specific polarization component L1-1 having specific polarization axis of a first light L1 corresponding to an internal light, and reflects other polarization components L1-2 of the first light L1. The light reflecting member 111 reflects a portion L2-1 of a specific polarization component of a second light L2 corresponding to an external light, and transmits remaining portion L2-2 of the specific polarization component of the second light L2. The light polarizing layer 115 is disposed over the light reflecting member 111. Therefore, most other components of the second light L2 do not arrive at the light reflecting member 111. In one example, a semi-reflective film or a metal transmission plate covering the first substrate 110 may be used as the light reflecting member 111.

The semi-reflective film has an anisotropy of refractivity, and reflects the specific component of the second light L2 by an amount between about 1% and about 10%. A transmissive axis of the semi-reflective film, which can transmit the specific polarization component L1-1 of the first light L1, is substantially the same as a reflective axis of the semi-reflective film, which can reflect the portion L2-1 of the specific polarization component of the second light L2.

When a metal transmission plate is employed as the light reflecting member 111, the metal transmission plate is thin such that the metal transmission plate can transmit a portion of a light and reflect a remaining portion of the light. The metal transmission plate has isotropy of refractivity. However, the above described semi-reflective film has anisotropy of refractivity.

The color filter layer 113 includes a red color filter R, a green color filter G, and a blue color filter B spaced apart from each other. The first light blocking layer 112 is disposed between the red, green, and blue color filters R, G, and B. Therefore, the first light blocking layer 112 discriminates colors to enhance color reproducibility. In order to reduce height difference between the color filter layer 113 and the first light blocking layer 112, the first leveling layer 114 is formed on the color filter layer 113 and the first light blocking layer 112. The first leveling layer 114 has a flat surface.

The light polarizing layer 115 is disposed on the first leveling layer 114. The light polarizing layer 115 polarizes the first and second lights L1 and L2. The light polarizing layer 115 may correspond to chemicals including iodine, dichroic dye, or lyotropic liquid crystal molecules. In one example, the light polarizing layer 115 has a thickness equal to or less than about 1 μm, and additionally a protection layer and an adhesive layer may be disposed on the upper and lower surface of the light polarizing layer 115. An example of components of the light polarizing layer 115 are disclosed in U.S. Pat. No. 6,563,640, which is incorporated by reference herein for all purposes.

The first protection layer 116 is disposed on the light polarizing layer 115 to protect the light polarizing layer 115. The common electrode 117 includes an optically transparent and electrically conductive material. The common electrode 117 formed on the first protection layer 116 has uniform thickness.

The thickness and material of the light reflecting member 111 determine a transmissivity and reflectivity of the first and second lights L1 and L2. In detail, when the thickness of the light reflecting member 111 decreases, the transmissivity of the first light L1 increases and a reflectivity of the second light L2 decreases. On the contrary, when the thickness of the light reflecting member 111 increases, the transmissivity of the first light L1 decreases and a reflectivity of the second light L1 increases.

FIG. 2 is a cross-sectional view illustrating a color filter panel according to another embodiment of the present invention. Referring to FIG. 2, a color filter panel 101 includes a first substrate 110, a light reflecting member 118, and a light polarizing layer 115. The light reflecting member 118 is repeatedly formed on a portion of the first substrate 110. The light polarizing layer 115 is disposed over the light reflecting member 118. A first light blocking layer 112 and a color filter layer 113 are interposed between the light reflecting member 118 and the light polarizing layer 115. A first leveling layer 114 is formed on the color filter layer 113 and the first light blocking layer 112. A first protection layer 116 and a common electrode 117 are formed over the light polarizing layer 115.

The light reflecting member 118 is at the portion of the first substrate 110, where unit cells displaying basis colors are formed. A region on which the light reflecting member 118 is formed corresponds to a reflection region 118a, and a region on which the light reflecting member 118 is not formed corresponds to a transmission region 118b. For example, the light reflecting member 118 is disposed on region of the first substrate, which is disposed between the color filters. Therefore, the light reflection region 118a alternates with the transmission region 118b.

A first light L1 generated from a light generating part (not shown) passes through the transmission region 118b to display an image, and a second light L2 that is external light is reflected on the reflection region 118a to display an image.

A lower light polarizing plate 120 is disposed under the color filter panel 101. A transmission axis of the lower light polarizing plate 120 is substantially the same as a transmission axis of the light polarizing layer 115. Alternatively, the lower light polarizing plate 120 may not be formed.

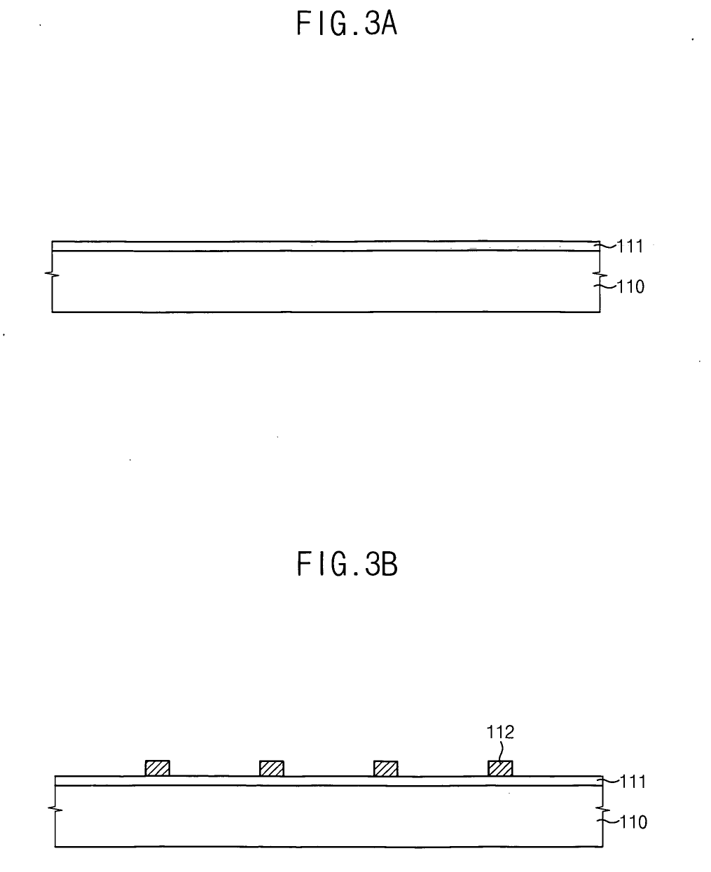

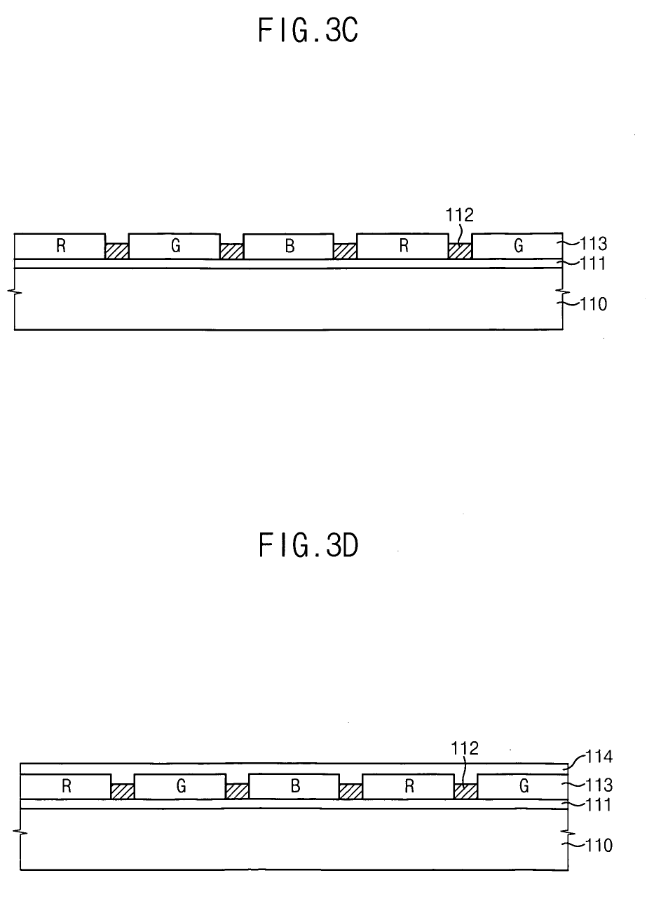

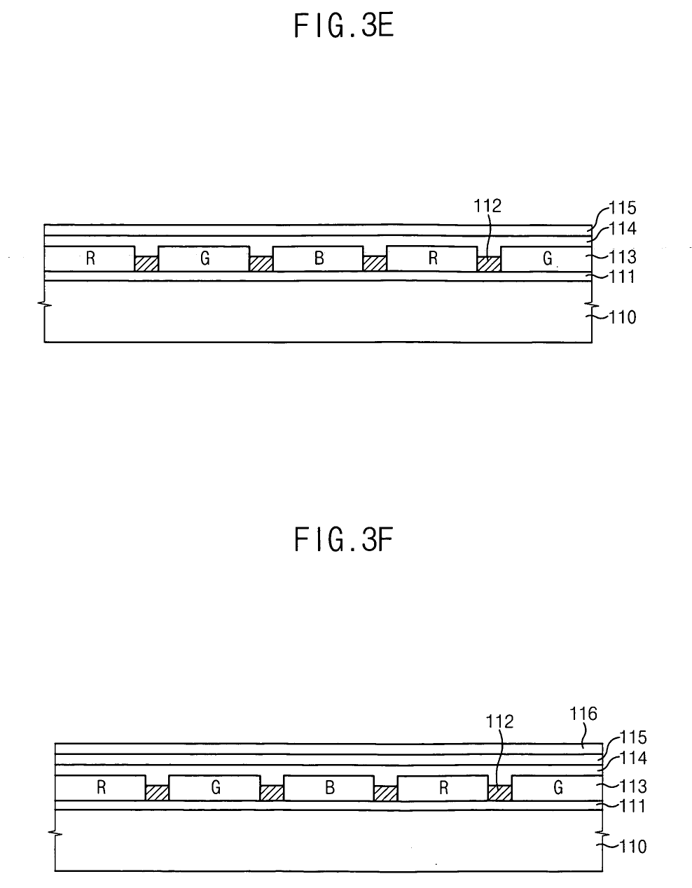

FIGS. 3A to 3F are cross-sectional views illustrating a method of manufacturing the color filter panel shown in FIG. 1.

Referring to FIG. 3A, the light reflecting member 111 (e.g., a semi-reflective film or a metal transmission plate) is formed on the first substrate 110 (e.g., glass or quartz). Referring to FIG. 3B, the first light blocking layer 112 is then formed on the light reflecting member 111. In one example, the first light blocking layer 112 is formed by patterning a black matrix (BM) layer including chromium oxide (CrO₂) or organic material.

Referring to FIG. 3C, the color filter layer 113 is formed next. A red color filter layer including a red color dye or pigment is formed on the first substrate 110 having the first light blocking layer 112 formed thereon. Then, the red color filter layer is patterned to form a red color filter R. A green color filter layer including a green color dye or pigment is formed on the first substrate 110 having the first light blocking layer 112 and the red color filter R formed thereon. Then, the green color filter layer is patterned to form a green color filter G. A blue color filter layer including a blue color dye or pigment is formed on the first substrate 110 having the first light blocking layer 112 and red and green color filters R and G formed thereon. Then, the blue color filter layer is patterned to form a red color filter B. Thus, the color filter layer 113 having the red, green, and blue color filters R, G, and B is formed.

Referring to FIG. 3D, the first leveling layer 114 having dielectric material is formed on the color filter layer 113 and the first light blocking layer 112. The first leveling layer 114 has a substantially planar surface, even when a surface formed by the color filter layer 113 and the first light blocking layer 112 is not flat. Therefore, the leveling layer 114 forms a substantially flat surface.

Referring to FIGS. 3E and 3F, the light polarizing layer 115 that polarizes the first and second light L1 and L2 is formed on the first leveling layer 114. The first protection layer 116 for protecting the light polarizing layer 115 is formed on the light polarizing layer 115.

A procedure of forming the light polarizing layer 115 may include in one example disposing chemicals having iodine, dichroic dye, or lyotropic liquid crystal, and rearranging molecules of the chemical toward a specific direction. In order to rearrange the molecules, chemical, mechanical, or electromagnetic stimulation may be performed. Additionally, the molecules may be mechanically fixed or dried on the first leveling layer 114 so that the molecules are rearranged. In one example, the light polarizing layer 115 has a thickness equal to or less than about 1 μm.

Referring again to FIG. 1, the common electrode 117 formed on the first protection layer 116 includes indium tin oxide (ITO) or indium zinc oxide (IZO) in one example and has uniform thickness in another example.

Referring again to the color filter panel of FIG. 2, in one example a thin metal plate is formed on the first substrate and patterned to form the reflecting member 118. The metal plate may include aluminum (Al) or aluminum alloy in one example.

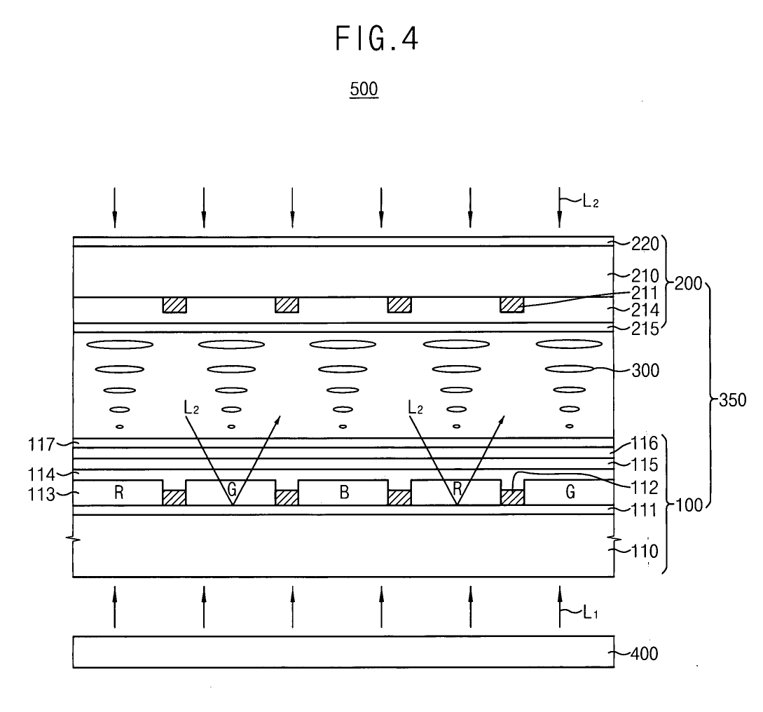

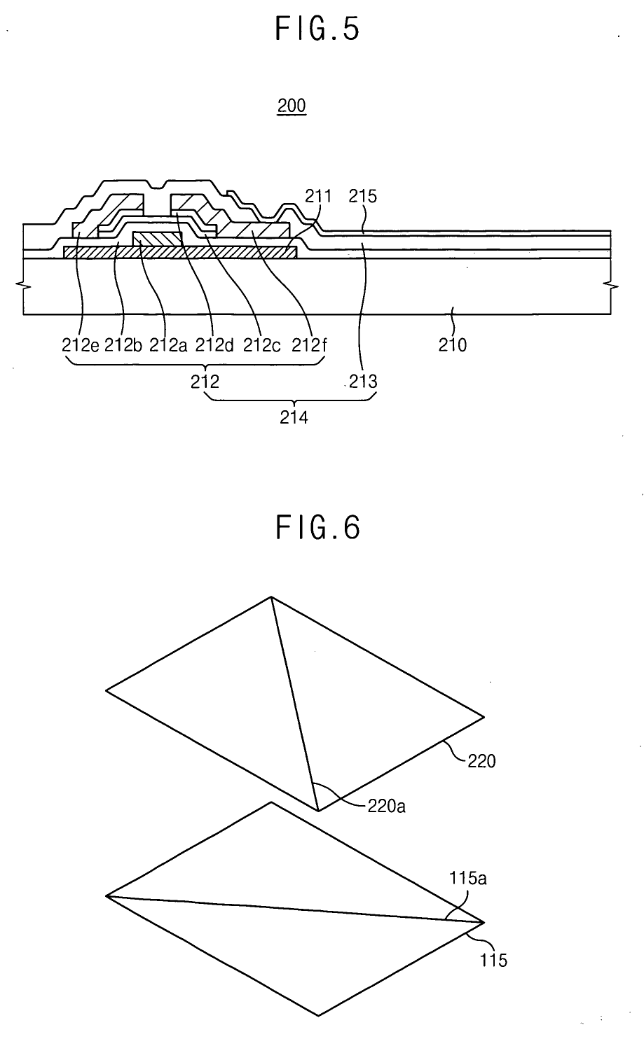

Referring now to FIGS. 4 and 5, a cross-sectional view of a display apparatus having the color filter panel of FIG. 1 is illustrated in FIG. 4, and a cross-sectional view of a switch panel is illustrated in FIG. 5.

Referring to FIG. 4, a display apparatus 500 having the color filter panel in FIG. 1 includes a light generating part 400 that generates the first light L1 and a display panel 350 that displays an image by using the first light L1 and a second light L2 that corresponds to an external light.

The display panel 350 includes a switch panel 200, a color filter panel 100 facing and spaced apart from the switch panel 200, and a liquid crystal layer 300 interposed between the switch panel 200 and the color filter panel 100.

The switch panel 200 includes a second substrate 210, a second light blocking layer 211 formed on a portion of the second substrate 210, a thin film transistor (TFT) array 214 formed on the second light blocking layer 211 and the second substrate 210, a pixel electrode 215 formed on the TFT array 214, and an upper light polarizing plate 220 disposed on the second substrate 210.

Referring to FIG. 5, the TFT array 214 includes a TFT 212 and the second protection layer 213 that protects the TFT 212. The TFT 212 includes a gate electrode 212a, a gate insulation layer 212b, an active layer 212c, an ohmic contact layer 212d, a source electrode 212e, and a drain electrode 212f.

The gate electrode 212a is formed on the second light blocking layer 211, and the gate insulation layer 212b is formed on the second substrate 210 and over the gate electrode 212a. The active layer 212c and the ohmic contact layer 212d are formed on the gate insulation layer 212b, such that the active layer 212c and the ohmic contact layer 212d are formed on a region corresponding to the gate electrode 212a. The source electrode 212e and the drain electrode 212f are formed on the ohmic contact layer, such that the source electrode 212e and the drain electrode 212f are spaced apart from each other.

The gate, source, and drain electrodes 212a, 212e, and 212f are disposed in a region in which the second light blocking layer 211 is formed. Therefore, the second light blocking layer 211 prevents the second light L2 from being reflected on the gate, source, and drain electrodes 212a, 212e, and 212f.

The second protection layer 213 formed on the TFT 212 exposes a portion of the drain electrode 212f of the TFT 212. The pixel electrode 215 is formed on the second protection layer 213 and electrically connected to the drain electrode 212f.

FIG. 6 is a schematic perspective view illustrating a relationship between transmission axes of a light polarizing layer and an upper light polarizing plate in FIG. 4. Referring now to both FIGS. 4 and 6, the upper light polarizing plate 220 is disposed on the second substrate 210. The upper light polarizing plate 220 has a first transmission axis 220a, so that the upper light polarizing plate 220 transmits a portion of the first and second lights L1 and L2 having specific oscillation axis. In other words, the upper light polarizing plate 220 polarizes the first and second lights L1 and L2. Therefore, when the first and second lights L1 and L2 pass through the upper light polarizing plate 220, the first and second lights L1 and L2 oscillate along the first transmission axis 220a.

In one example, as shown in FIG. 6, the light polarizing layer 115 coated on the color filter panel 100 has a second polarization axis 115a that is substantially perpendicular to the first polarization axis 220a. Alternatively, the first and second polarization axis 220a and 115a may be substantially parallel with each other in accordance with the kind of liquid crystal in liquid crystal layer 300 and the desired characteristics of the display apparatus. The transmission axis of the light reflecting member 111 has substantially the same direction as the transmission axis 115a of the light polarizing layer 115.

In another embodiment, a lower light polarization plate may be additionally disposed under the first substrate. A transmission axis of the lower light polarization plate has substantially the same direction as that of the light reflecting member 111 and the light polarizing layer 115.

The first and second lights L1 and L2 transmitted or reflected by the light reflecting member 111 is polarized by the light polarizing layer 115, passes through the liquid crystal layer 300, and is polarized again by the upper light polarizing plate 220.

As described above, the light reflecting member 111 and the light polarizing layer 115 are formed on the first substrate during a process of forming the color filter panel 100. Advantageously, the manufacturing time is reduced in comparison with the typical case of attaching a plate having the same function as the first substrate 110, the light reflecting member 111, and/or the light polarizing layer 115. Additionally, defects of attachment and misalignment between the first substrate 110 and the plate are prevented to enhance productivity.

Furthermore, by forming the light reflecting member 111 and the light polarizing layer 115 inside of the display panel 350, a path of the second light L2 may be reduced in comparison with a case that a lower light polarizing plate and a light reflecting member are formed under the first substrate. Therefore, luminance is enhanced.

Furthermore, a color of the second light L2 reflected on the light reflecting member 111 (or 118 in FIG. 2) is not distorted, because both the color filter layer 113 and the light reflecting member 111 are formed on the first substrate 110. For example, the second light L2 that passes through the red color filter of the color filter layer 113 and arrives at the light reflecting member 111 (or 118 in FIG. 2) is reflected on the light reflecting member 111 (or 118 in FIG. 2) and passes through the red color filter again, so that the color is not distorted, thereby enhancing display quality.

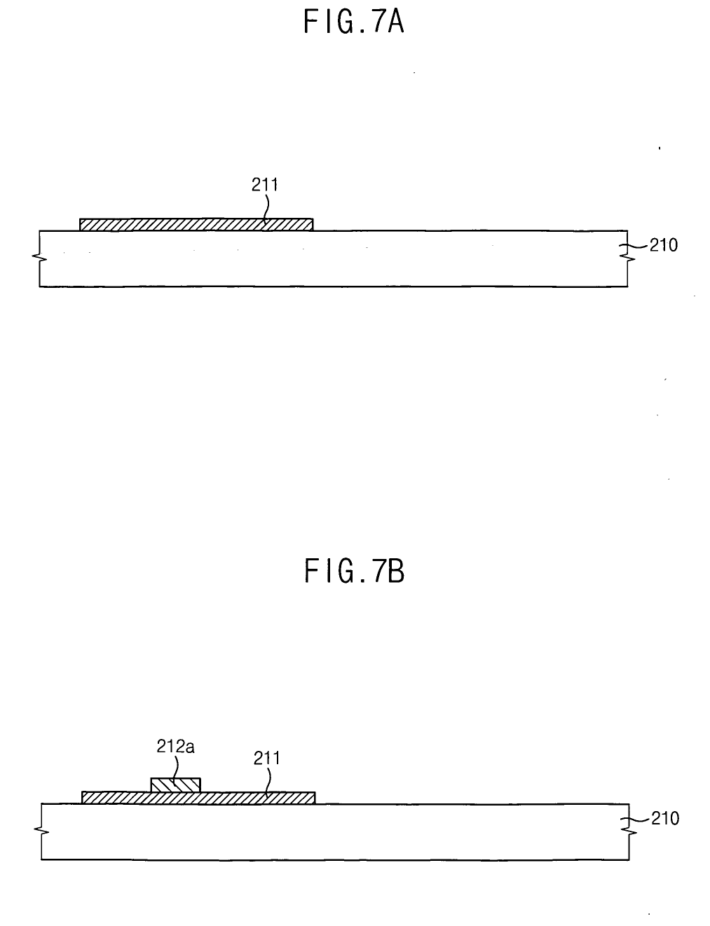

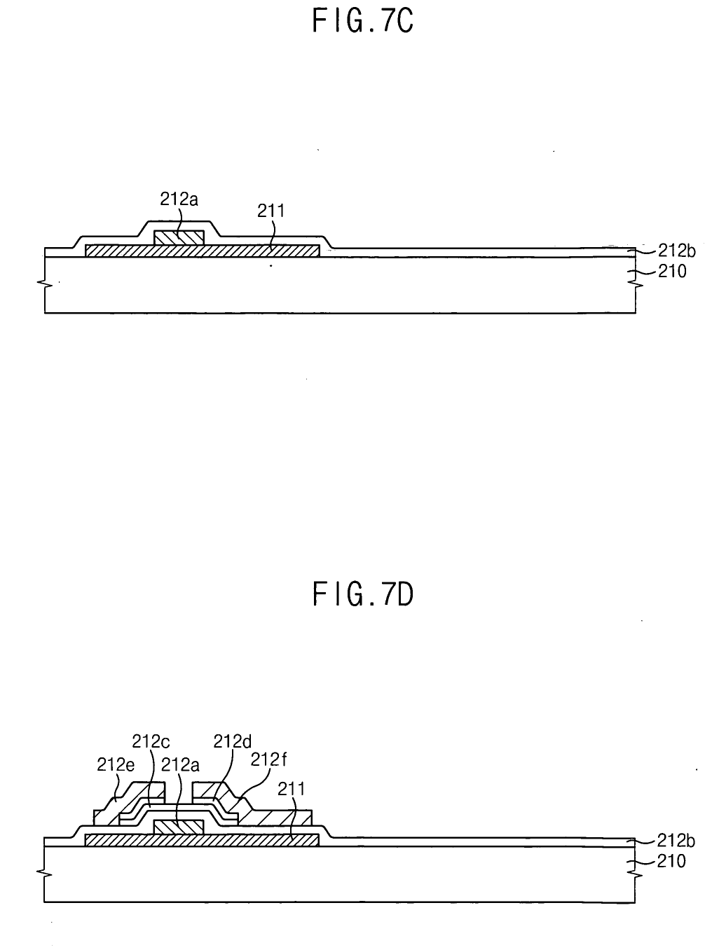

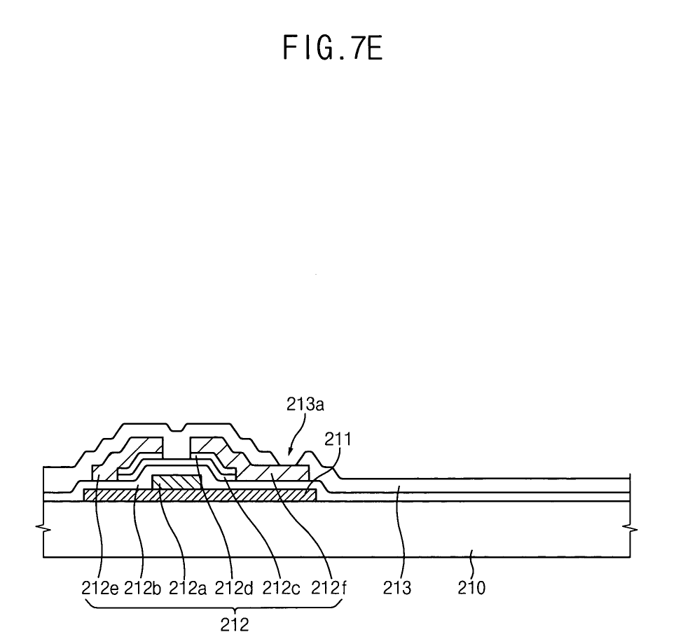

FIGS. 7A to 7E are cross-sectional views illustrating a method of manufacturing the switch panel in FIG. 5.

Referring to FIG. 7A, the black matrix layer is formed on the second substrate 210 including glass or quartz. Then, the black matrix layer is patterned to form the second light blocking layer 211.

Referring to FIG. 7B, a first metal layer including aluminum (Al), chromium (Cr), molybdenum tungsten (MoW), or a mixture thereof, is formed over the second substrate 210 and the second light blocking layer 211 for example by a sputtering method. Then, the first metal layer is patterned to form the gate electrode 212a on the second light blocking layer 211.

Referring to FIG. 7C, a silicon nitride (SiNₓ) layer is formed, for example, by chemical vapor deposition (CVD), to form the gate insulation layer 212b over the second substrate 210 having the gate electrode 212a formed thereon,.

Referring to FIG. 7D, a first amorphous silicon layer is formed on the gate insulation layer 212b, for example by CVD. Additionally, a second amorphous silicon layer having electron doping (N-type) is formed on the first amorphous silicon layer, for example by CVD. The first and second amorphous silicon layers may be formed by an in-situ process in the same CVD chamber in one embodiment. Then, the first and second amorphous silicon layers are patterned to form the active layer 212c and the ohmic contact layer 212d on a region corresponding to the gate electrode 212a.

A second metal layer including chromium (Cr), aluminum (Al), or aluminum alloy, for example aluminum neodymium (AlNd), is formed on the gate insulation layer 212b and the ohmic contact layer 212d, for example by a sputtering method. Then, the second metal layer is patterned to form the source and drain electrodes 212e and 212f spaced apart from each other.

Referring to FIG. 7E, the insulation layer-including silicon nitride (SiNₓ) or silicon oxide (SiOₓ) is formed over the second substrate 210 having the TFT 212 formed thereon. Then, the insulation layer is patterned to expose the drain electrode 212f of the TFT 212 at a region 213a. Thus, the second protection layer 213 is formed.

Referring again to FIG. 5, the pixel electrode 215 including ITO or IZO is formed on the second protection layer 213, such that the pixel electrode 215 is electrically connected to the drain electrode 212f. Thus, the switch panel 200 is formed.

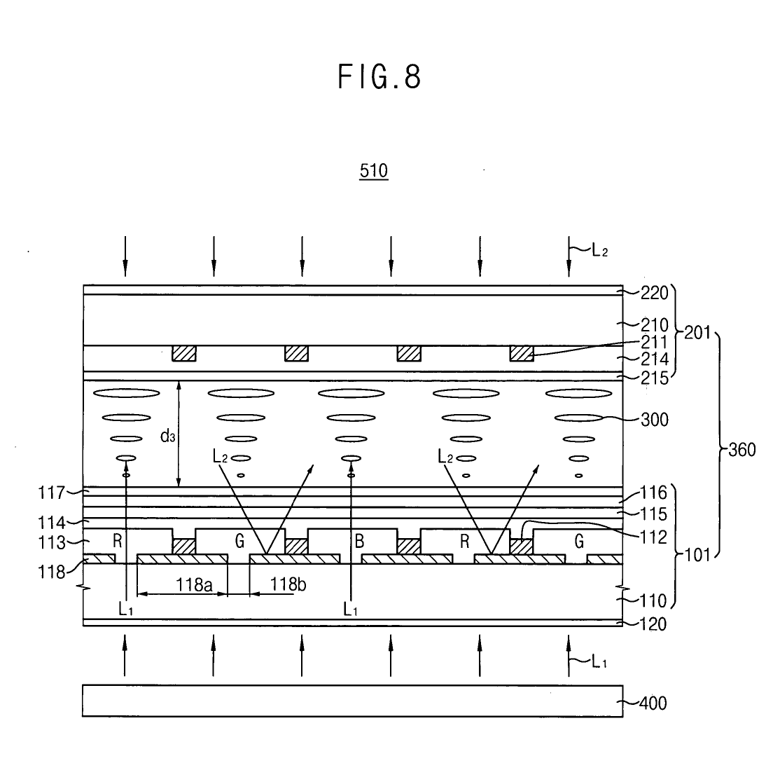

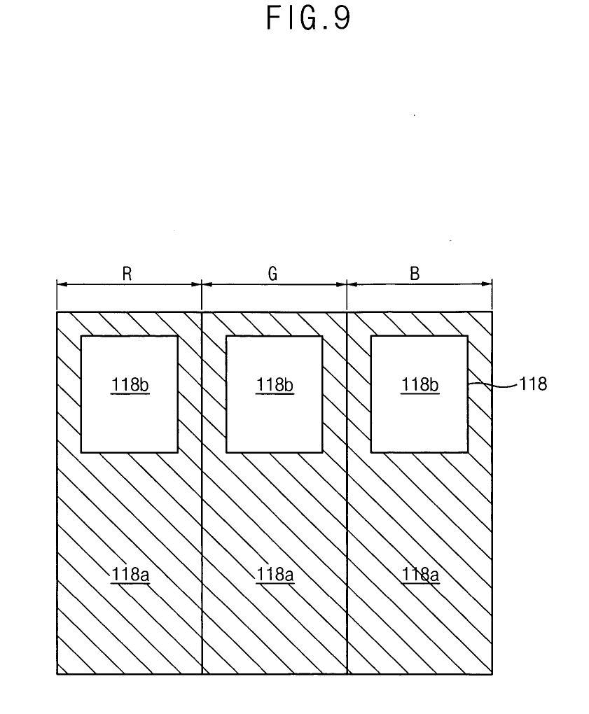

FIG. 8 is a cross sectional view illustrating a display panel employing the color filter panel in FIG. 2, and FIG. 9 is a plan view illustrating a reflecting member formed on a first substrate of the color filter panel in FIG. 8.

Referring to FIGS. 8 and 9, a display apparatus 510 includes a display panel 360 and a light generating part 400. The display panel 360 displays an image by using the first and second lights L1 and L2. The light generating part 400 provides the display panel 360 with the first light L1.

The display panel 360 includes lower and upper light polarizing plates 120 and 220. The lower light polarizing plate 120 is disposed under the color filter panel 101 and polarizes the first light L1. The upper polarizing plate 220 is disposed on the switch panel 201 and polarizes the first and second lights L1 and L2.

The color filter panel 101 includes a first substrate 110, a light reflecting member 118 disposed on the first substrate 110, and a light polarizing layer 115 disposed over the light reflecting member 118.

The light reflecting member 118 may be a metal plate in one embodiment. The metal plate is repeatedly formed on a portion of the first substrate 110. The metal plate is at the portion of the first substrate 110 where unit cells displaying basis colors are formed. A region on which the metal plate 118 is formed corresponds to a reflection region 118a, and a region on which the metal plate is not formed corresponds to a transmission region 118b. In one example, the metal plate includes metal that has high reflectivity, for example such as chromium (Cr) or aluminum (Al).

Although not shown in FIG. 8, in order to enhance the reflectivity of the metal plate, the metal plate may be treated or processed. For example, an organic layer (not shown) having an embossing pattern may be interposed between the first substrate 110 and the metal plate. Therefore, the metal plate formed on the organic layer may have an embossing pattern. Alternatively, the metal plate may be etched to form the embossing pattern.

The metal plate is first formed on the entire upper surface of the first substrate 110 for example by sputtering method. Then, a portion of the metal plate is removed to form the transmission region 118b, for example by a photolithography process.

The first light blocking layer 112, the color filter layer 113, the first protection layer 116, the common electrode 117, and the first leveling layer 114 have the same or substantially similar structure as the elements of the color filter panels shown and described above with respect to FIGS. 1 to 3. Therefore, further explanation will be omitted.

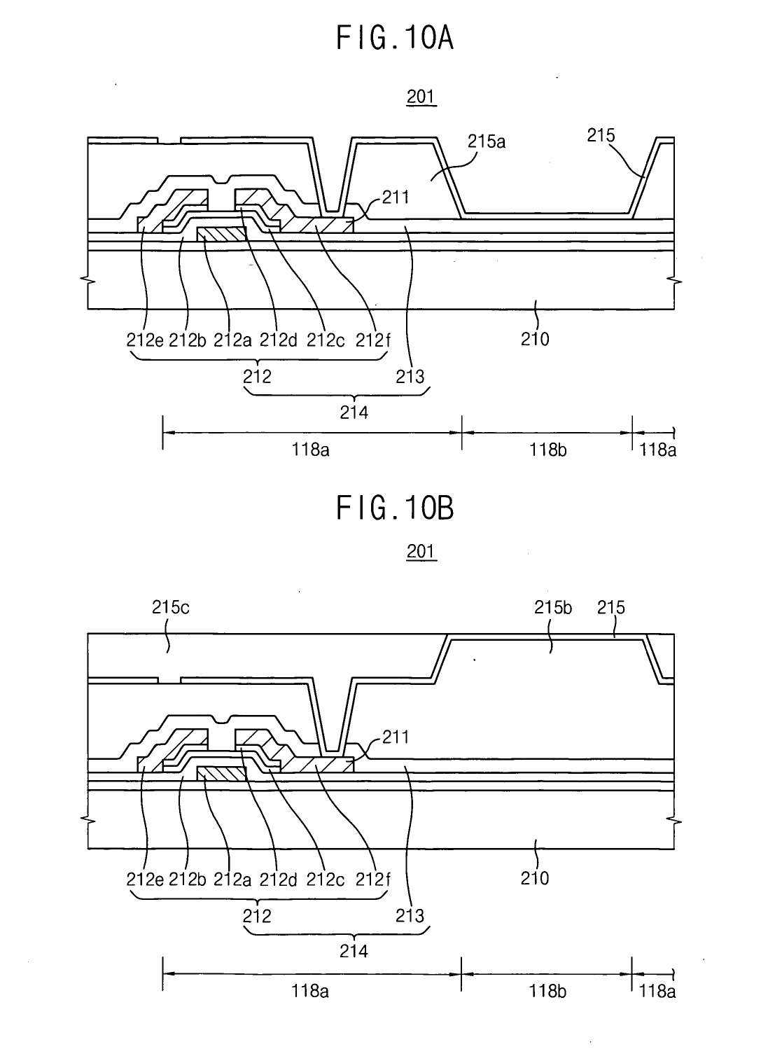

FIGS. 10A and 10B are cross-sectional views illustrating a switch panel in FIG. 8. The switch panel 201 in FIG. 8 may have a structure of the switch panel 200 in FIG. 5.

Referring to FIG. 10A, the switch panel 201 includes a second light blocking layer 211, a TFT 212 that is disposed over the second substrate 210, and a second protection layer 213 formed on the TFT 212. The second protection layer 213 has a contact hole that exposes a drain electrode 212f of the TFT 212. Then, an insulation layer 215a is formed on the second protection layer 213. The insulation layer 215a has also a connection hole corresponding to the connection hole of the second protection layer 213. Therefore, the drain electrode 212f is exposed. An organic insulation layer may be used as the insulation layer 215a . The insulation layer 215a has different thickness according to regions. In detail, the insulation layer 215a of the reflection region 118a has different thickness from that of the insulation layer 215a of the transmission region 118b . The insulation layer 215a of the transmission region 118b is thinner than the insulation layer 215a of the reflection region 118a . The insulation layer 215a of the transmission region 118b may be removed as shown in FIG. 10A. A thickness of the insulation layer 215a may be adjusted such that a cell gap of the transmission region 118b becomes double of a cell gap of the reflection region 118a.

The second light L2 that is an external light passes through a liquid crystal layer two times in order to display an image, and the first light L1 that is generated from the light generating part passes through the liquid crystal one time in order to display an image. Therefore, a portion of image displayed through the transmission region 118b and a portion of image displayed through the reflection region 118a are not uniform. The difference of light path between the transmission region 118b and the reflection region 118a may be compensated by adjusting the thickness of the insulation layer 215a.

Referring to FIG. 10B, the switch panel 201 includes a second light blocking layer 211, a TFT 212 that is disposed over the second substrate 210, and a second protection layer 213 formed on the TFT 212. The second protection layer 213 has a contact hole that exposes a drain electrode 212f of the TFT 212. Then, an insulation layer 215b is formed on the second protection layer 213. The insulation layer 215b has also a connection hole corresponding to the connection hole of the second protection layer 213. Therefore, the drain electrode 212f is exposed. An organic insulation layer may be used as the insulation layer 215b . The insulation layer 215b has different thickness according to regions. In detail, the insulation layer 215b of the reflection region 118a has different thickness from that of the insulation layer 215b of the transmission region 118b. The insulation layer 215b of the transmission region 118b is thicker than the insulation layer 215b of the reflection region 118a . The pixel electrode 215 is formed on the insulation layer 215b . The pixel electrode 215 has different height according to the reflection region 118a and the transmission region 118b due to the insulation layer 215b . Then, another insulation layer 215c is formed in the reflection region 118a to compensate for the height difference between the reflection region 118a and the transmission region 118b.

The second light L2 that is an external light passes through a liquid crystal layer two times in order to display an image, and the first light L1 that is generated from the light generating part passes through the liquid crystal one time in order to display an image. Therefore, a portion of image displayed through the transmission region 118b and a portion of image displayed through the reflection region 118a are not uniform. The difference of light path between the transmission region 118b and the reflection region 118a may be compensated by adjusting electric fields formed between the pixel electrode 215 and the common electrode (not shown) disposed over the pixel electrode 215.

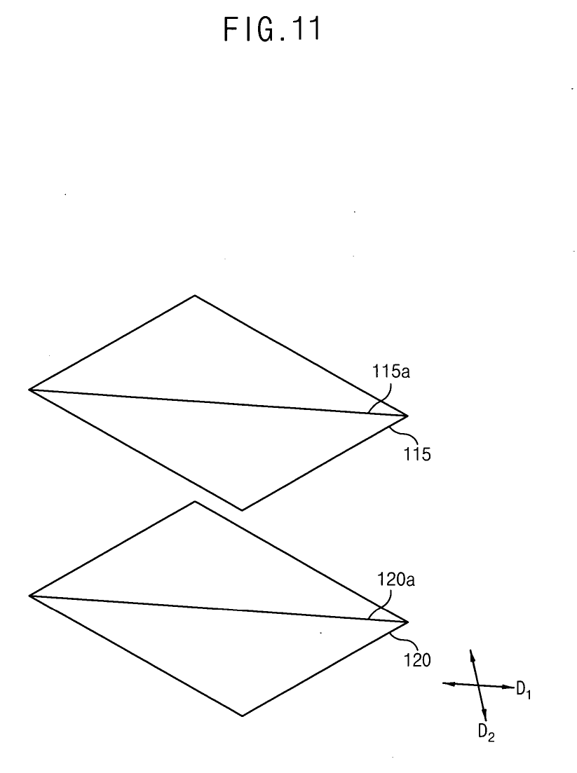

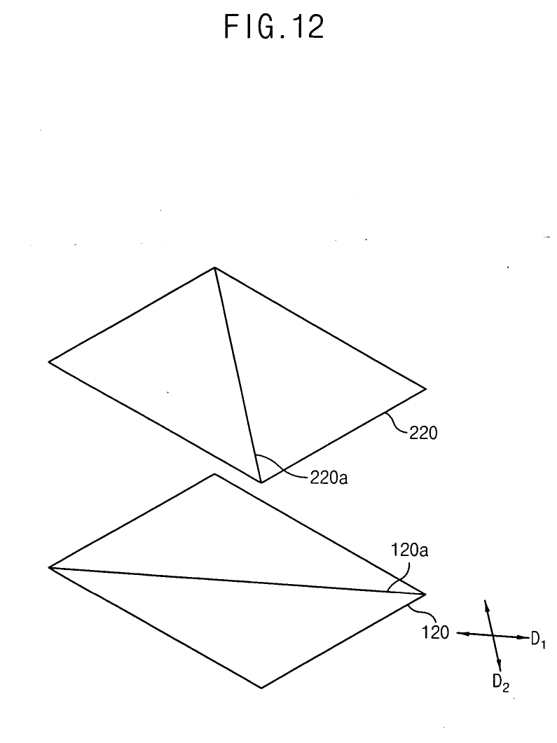

FIG. 11 is a schematic perspective view illustrating a relationship between transmission axes of a light polarizing layer and a lower light polarizing plate in FIG. 8, and FIG. 12 is a schematic perspective view illustrating a relationship between transmission axes of a light polarizing layer and an upper light polarizing plate in FIG. 8.

Referring to FIGS. 8 and 11, a lower light polarizing plate 120 linearly polarizes the first light L1 provided from the light generating part 400. A light polarizing layer 115 disposed in the color filter panel 101 linearly polarizes the second light L2 reflected on the light reflecting member 118 and the first light L1 that passes through the transmission region 118b . A transmission axis 115a of the light polarizing layer 115 is substantially parallel with a transmission axis 120a of the lower light polarizing plate 120.

The lower light polarizing plate 120 transmits a portion of the first light L1, which oscillates along a first direction D1 that is parallel with the transmission axis 120a, and absorbs a portion of the first light L1, which oscillates along a second direction D2 that is perpendicular to the first direction D1 to linearly polarize the first light L1. The light polarizing layer 115 linearly polarizes the first light L1 that passes through the lower light polarizing plate 120. The light polarizing layer 115 transmits a portion of the second light L2, which oscillates along the first direction D1, and absorbs a portion of the second light L2, which oscillates along the second direction D2 to linearly polarize the second light L2.

Referring to FIG. 12, an upper light polarizing plate 220 has a transmission axis 220a that polarizes the first light L1 that passes through the transmission region 118b and the second light L2. The transmission axis 220a of the upper light polarizing plate 220 is substantially perpendicular to the transmission axis 120a of the lower light polarizing plate 120. The upper light polarizing plate 220 transmits a portion of the first and second lights L1 and L2, which oscillates along the second direction D2 that is parallel to transmission axis 220a of the upper light polarizing plate 220 and absorbs a portion of the first and second lights L1 and L2, which oscillates along the first direction D1.

In one embodiment as described above, the display apparatus 510 of FIG. 8 includes not only the light polarizing layer 115 but also the lower and upper light polarizing plates 120 and 220 disposed on lower and upper surfaces of the display panel 360. Therefore, the first and second lights L1 and L2 are completely polarized to enhance a contrast ratio. Alternatively, the display apparatus 510 may not employ the lower polarizing plate 120 according to desired characteristics of the display apparatus 510.

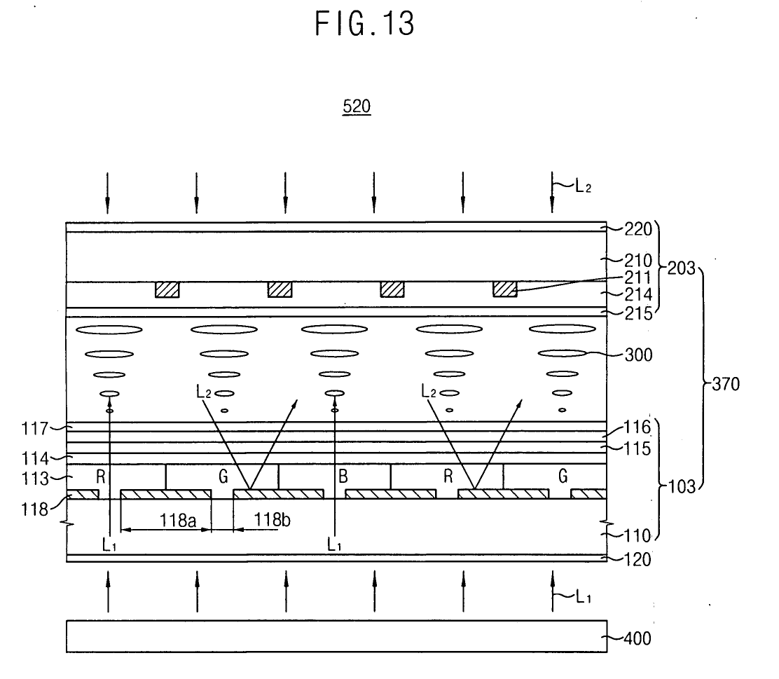

FIG. 13 is a cross-sectional view illustrating a display apparatus according to another embodiment of the present invention. Referring to FIG. 13, a color filter panel 103 of a display apparatus 520 according to another embodiment of the present invention does not employ the first light blocking layer 112 in FIG. 2. The light reflecting member 118 is formed on the first substrate 110 of the color filter panel 103, and red, green, and blue color filter layers 113 are formed on the light reflecting member 118. The first light blocking layer 112 in FIG. 2 is not formed between the red, green, and blue color filter layers 113 adjacent to each other.

A plurality of gate lines (not shown) and a plurality of data lines (not shown) are formed on the second substrate 210 of the switch panel 203. The data lines are substantially perpendicular to the gate lines. The TFT array 214 is formed in a region defined by each data line and each gate line. A region in which the data lines and the gate lines are formed correspond to a region between the red, green, and blue color filters. Therefore, each of the gate lines and data lines divides the color filters as the first light blocking layer 112 in FIG. 2 does to enhance color reproducibility. Alternatively, a black matrix layer may be formed under the gate lines and the data lines.

When the first light blocking layer 112 in FIG. 2 is omitted, a process of manufacturing the color filter panel 103 is simplified. Therefore, manufacturing time is reduced to enhance productivity.

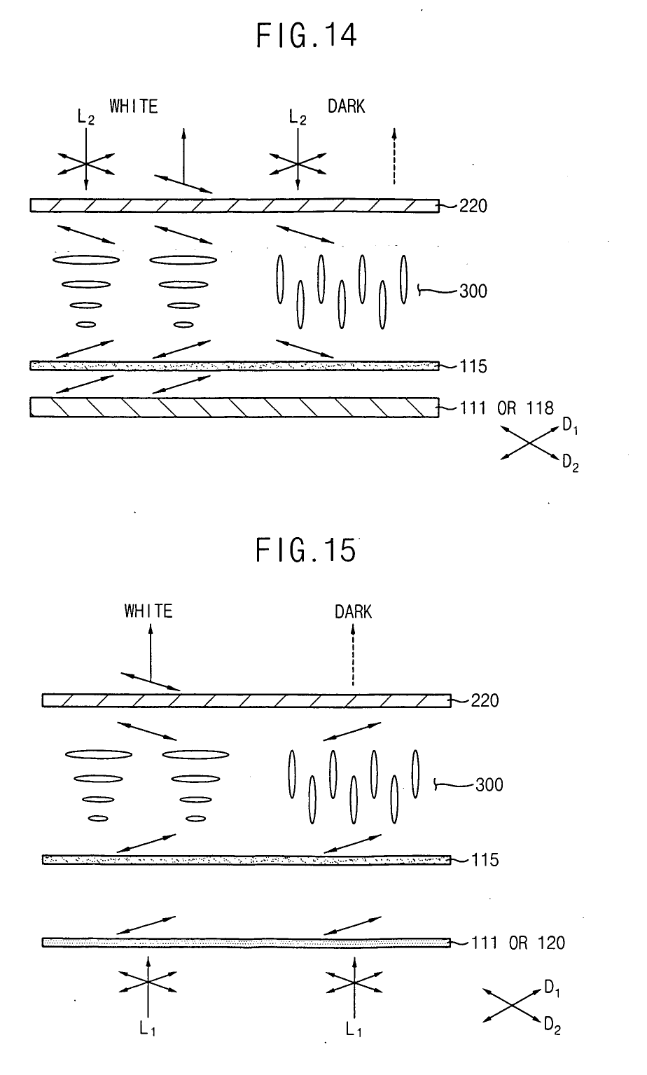

FIG. 14 is a schematic view illustrating a light polarizing state, when a display panel according to the present invention displays an image by using a second light L2 that corresponds to an external light. Referring to FIG. 14, when the liquid crystal layer 300 of display apparatuses 500 (FIG. 4), 510 (FIG. 8), and 520 (FIG. 13) is in a state in which the liquid crystal layer 300 may cause a half wavelength phase modulation of a light (i.e., a white region of the left side of FIG. 14), the upper light polarizing plate 220 transmits a portion of the second light L2, which oscillates along the second direction D2 to linearly polarize the second light L2. The linearly polarized second light L2 is converted to oscillate along the first direction D1 during passing through the liquid crystal layer 300. The light polarizing layer 115 transmits the second light L2 that oscillates along the first direction D1. The second light L2 that oscillates along the first direction D1 is reflected on the light reflecting member 111 or 118 and advances toward the light polarizing layer 115.

When the light reflecting member 111 or 118 is a semi-reflective film, about 1% to about 10% of light that is incident on the semi-reflective film is reflected, and about 90% to about 99% of the light passes through the semi-reflective film. A portion of the light that passes through the semi-reflective film is absorbed by the light generating part (not shown), and a remaining portion of the light is reflected and advances with the first light L1 provided from the light generating part toward the light polarizing layer 115.

The second light L2 that is incident on the light polarizing layer 115 passes through the light polarizing layer 115 and is converted to oscillate along the second direction D2 by the liquid crystal layer 300. The upper light polarizing plate 220 directly transmits the light that oscillates along the second direction D2. Therefore, the display apparatuses 500, 510, and 520 display a white image.

When the liquid crystal layer 300 of display apparatuses 500, 510, and 520 is in a state in which the liquid crystal layer 300 may not cause a phase modulation of a light (i.e., a dark region of the right side of FIG. 14), the upper light polarizing plate 220 transmits a portion of the second light L2, which oscillates along the second direction D2 to linearly polarize the second light L2. The linearly polarized second light L2 directly passes through the liquid crystal layer 300. That is, an oscillation axis of the linearly polarized second light L2 is not changed while passing through the liquid crystal layer 300. Therefore, the second light L2 may not pass through the light polarizing layer 115, so that the display apparatuses 500, 510, and 520 display a black image.

FIG. 15 is a schematic view illustrating a polarizing state, when a display panel according to the present invention displays an image by using a first light L1 that corresponds to an internal light. Referring to FIG. 15, the lower light polarizing plate 120 or the light reflecting member 111 transmits a portion of the first light L1, which oscillates along the first direction D1 to linearly polarize the first light L1. The linearly polarized first light L1 is again linearly polarized by the light polarizing layer 115 to advance toward the liquid crystal layer 300.

When the liquid crystal layer 300 of display apparatuses 500, 510, and 520 is in a state in which the liquid crystal layer 300 may cause a half wavelength phase modulation of a light (i.e., a white region of the left side of FIG. 15), the first light L1 that oscillates along the first direction D1 is converted to oscillate along the second direction D2 while passing through the liquid crystal layer 300. The upper light polarizing plate 220 transmits the first light that oscillates along the second direction D2. Therefore, the display apparatuses 500, 510, and 520 display a white image.

When the liquid crystal layer 300 of display apparatuses 500, 510, and 520 is in a state in which the liquid crystal layer 300 may not cause a phase modulation of a light (i.e., a dark region of the right side of FIG. 15), the first light L1 that oscillates along the first direction D1 directly passes through the liquid crystal layer 300. That is, an oscillation direction is not changed even though the first light L1 passes through the liquid crystal layer 300. Therefore, the first light L1 that oscillates along the first direction D1 may not passes through the upper polarizing plate 220, so that the display apparatuses 500, 510, and 520 display a black image.

According to the present invention, the display panel and the display apparatus having the display panel include a light reflecting member that transmits a portion of the first and second lights and reflects a remaining portion of the first and second lights, and a polarizing layer that polarizes the first and second lights that are transmitted or reflected by the light reflecting member.

Advantageously, the time for manufacturing the display panel is reduced. Furthermore, misalignment between the first substrate and the light reflecting member or between the first substrate and the light polarizing layer, both of which can occur when the light reflecting member or the light polarizing layer formed in a plate type, is reduced to enhance productivity.

Additionally, the color filter layer is formed on the reflecting member. Therefore, the second light before and after being reflected by the light reflecting member has the same color. That is, the second light maintains color even when the second light is reflected by the light reflecting member. Therefore, display quality is enhanced.

Having described embodiments of the present invention and its advantages, it is noted that various changes, substitutions, and alterations can be made herein without departing from the spirit and scope of the invention as defined by the appended claims.

1. A color filter panel, comprising:
a first substrate;
a light reflecting member formed on the first substrate, the light reflecting member reflecting at least a portion of an external light;
a color filter formed on the light reflecting member; and
a light polarizing layer formed over the color filter.

2. The color filter panel of claim 1, wherein the light polarizing layer comprises a chemical compound having iodine, dichroic dye, or lyotropic liquid crystal.

3. The color filter panel of claim 1, wherein the light polarizing layer has a thickness equal to or less than about 1 μm.

4. The color filter panel of claim 1, wherein the light reflecting member is a semi-reflective film.

5. The color filter panel of claim 4, wherein the semi-reflective film reflects a light having a specific polarizing axis by about 1% to about 10%, transmits the light having the specific polarizing axis by about 90% to about 99%, and reflects the light having other polarizing axes.

6. The color filter panel of claim 4, wherein a transmission axis of the semi-reflective film is substantially the same as a transmission axis of the light polarizing layer.

7. The color filter panel of claim 1, wherein the light reflecting member is a thin metal film that transmits a portion of a light and reflects a remaining portion of the light.

8. The color filter panel of claim 1, wherein the light reflecting member is formed on a portion of the first substrate and includes a metal that reflects the majority of a light.

9. The color filter panel of claim 8, wherein the light reflecting member includes an embossing pattern.

10. The color filter panel of claim 9, further comprising an insulation layer that is interposed between the light reflecting member and the first substrate, the insulation layer having an embossing pattern corresponding to the embossing pattern of the light reflecting member.

11. The color filter panel of claim 1, further comprising a common electrode disposed over the light polarizing layer.

12. A display panel, comprising:
a color filter panel including a first substrate, a light reflecting member formed on the first substrate, the light reflecting member reflecting at least a portion of an external light, a color filter formed on the light reflecting member, and a light polarizing layer formed over the color filter;
a switch panel operably coupled to the color filter panel, the switch panel including a second substrate, a black matrix formed on a portion of the second substrate, a thin film transistor formed on the black matrix, and a pixel electrode that is electrically connected to the thin film transistor; and
a liquid crystal layer interposed between the color filter panel and the switch panel.

13. The display panel of claim 12, further comprising an insulation layer interposed between the thin film transistor and the pixel electrode of the switch panel, the insulation layer having a different thickness in a reflection region as compared to a transmission region.

14. The display panel of claim 13, wherein a thickness of the insulation layer of the reflection region is thicker than a thickness of the insulation layer of the transmission region.

15. The display panel of claim 13, wherein a thickness of the insulation layer of the reflection region is smaller than a thickness of the insulation layer of the transmission region.

16. The display panel of claim 15, further comprising a first insulation layer disposed on the pixel electrode of the reflection region.

17. The display panel of claim 13, further comprising a first insulation layer disposed on the pixel electrode of the reflection region.

18. A display apparatus, comprising:
a light generating part;
a color filter panel that is adjacent to the light generating part, the color filter panel including a first substrate, a light reflecting member formed on the first substrate, the light reflecting member reflecting at least a portion of an external light, a color filter formed on the light reflecting member, and a light polarizing layer formed over the color filter;
a switch panel operably coupled to the color filer panel, the switch panel including a second substrate, a black matrix formed on a portion of the second substrate, a thin film transistor formed on the black matrix, and a pixel electrode that is electrically connected to the thin film transistor; and
a liquid crystal layer interposed between the color filter panel and the switch panel.

19. A method of manufacturing a color filter panel, comprising:
forming a light reflecting member that reflects at least a portion of an external light on a first substrate;
forming a color filter layer on the light reflecting member; and
forming a light polarizing layer over the color filter layer.

20. The method of claim 19, wherein the light polarizing layer has a thickness equal to or less than about 1 μm.

21. The method of claim 19, wherein the light reflecting member corresponds to a semi-reflective film having a transmission axis substantially parallel with a transmission axis of the light polarizing layer.

22. The method of claim 19, wherein the light reflecting member is formed by:
forming a metal plate on the first substrate; and
removing a portion of the metal plate.
